(19) United States
(12) Patent Application Publication
(10) Pub. No.: US 2025/0203364 A1
(43) Pub. Date: Jun. 19, 2025

(54) ENHANCED WIRELESS SECURITY

(71) Applicants: Po-Kai Huang, San Ramon, CA (US); Johannes Berg, Detmold (DE); Ido Ouzieli, Tel Aviv (IL); Ilan Peer, Modiin (IL)

(72) Inventors: Po-Kai Huang, San Ramon, CA (US); Johannes Berg, Detmold (DE); Ido Ouzieli, Tel Aviv (IL); Ilan Peer, Modiin (IL)

(21) Appl. No.: 19/069,656

(22) Filed: Mar. 4, 2025

Related U.S. Application Data
(60) Provisional application No. 63/702,385, filed on Oct. 2, 2024.
(60) Provisional application No. 63/651,597, filed on May 24, 2024.

(51) Int. Cl. H04W 12/06; H04W 12/0431; H04W 84/12

(52) U.S. Cl. CPC H04W 12/06; H04W 12/0431; H04W 84/12

(57) ABSTRACT

This disclosure describes systems, methods, and devices related to using pairwise master key security association (PMKSA) caching for authentication and time synchronization factor security. A method may include sending a first message of an 802.1X authentication frame exchange, including an indication of a first pairwise master key identifier (PMKID) associated with one or more PMKSA identifiers; identifying a second PMKID indicated in a second message of the 802.1X authentication frame exchange, received from a responder device; determining that second PMKID matches the first PMKID; storing a PMKSA identifier corresponding to the second PMKID; and sending an association request frame to the responder device based on determining that the second PMKID matches the first PMKID, wherein the association request frame is sent in succession with receiving the second message of the 802.1X authentication frame exchange.

### CROSS-REFERENCE TO RELATED PATENT APPLICATION(S)

This application claims the benefit of U.S. Provisional Application No. 63/702,385, filed Oct. 2, 2024, and of U.S. Provisional Application No. 63/561,597, filed Mar. 5, 2024, the disclosures of which are incorporated herein by reference as if set forth in full.

### TECHNICAL FIELD

This disclosure generally relates to systems and methods for wireless communications and, more particularly, to timing synchronization function protection and fast pairwise master key security association (PMKSA) caching for faster authentication and association.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment, in accordance with one or more example embodiments of the present disclosure.

FIG. 2 shows a flow diagram for pairwise master key identifier (PMKID) authentication optimization, in accordance with one or more example embodiments of the present disclosure.

FIG. 3 shows a flow diagram for PMKID authentication optimization, in accordance with one or more example embodiments of the present disclosure.

FIG. 4 illustrates a flow diagram of illustrative process for using pairwise master key security association (PMKSA) caching for authentication, in accordance with one or more example embodiments of the present disclosure.

FIG. 5 illustrates a functional diagram of an exemplary communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

FIG. 7 is a block diagram of a radio architecture in accordance with some examples.

FIG. 8 illustrates an example front-end module circuitry for use in the radio architecture of FIG. 7, in accordance with one or more example embodiments of the present disclosure.

FIG. 9 illustrates an example radio IC circuitry for use in the radio architecture of FIG. 7, in accordance with one or more example embodiments of the present disclosure.

FIG. 10 illustrates an example baseband processing circuitry for use in the radio architecture of FIG. 7, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define Wi-Fi communications, including secure transmissions of wireless frames. Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

In 802.11, the timing synchronization factor (TSF) field, also referred to as time stamp field, in certain frames (e.g., beacon, probe response, time advertisement) is used to synchronize between an access point (AP) and non-AP stations (STAs) in a given basic service set (BSS).

In the IEEE definitions of beacon protection, the TSF was defined to be muted (e.g., set to zero) for purposes of a message integrity check (MIC) calculation over beacon frames. No form of protection currently applies to other 802.11 frames carrying the TSF field. As a consequence, there is currently no form of protection for the time synchronization, and attackers may record/jam/replay frames with a different TSF.

Additionally, TSF is being considered for use for security purposes, e.g. for use as (part of the) IV in an 802.11 control frame and/or header protection, and other features such as target wake time (TWT) rely on timing. Consequently, protecting the TSF is or will become necessary.

One proposed solution to this problem is by calculating a MIC over the TSF field, and include that in the (beacon) frame as a new element. However, this is complex: It will likely require new hardware to calculate the MIC, because it must be done in parallel to (or at least before) the MIC of the entire frame is checked, because: For backward compatibility reasons, the contents of this new element need to be covered by the entire frame's MIC. Also, for backward compatibility reasons, the element cannot be after the management entity (MME) element containing the MIC of the frame content. In addition, covering the Timestamp Field by the regular MIC rather than muting it creates a similar backward compatibility issue. Therefore, any of this protection necessarily introduces a dependency from the value of the Timestamp Field to the frame's MIC in the MME, so the MME cannot be pre-calculated before setting the value of the Timestamp Field.

Also in 802.11, pairwise master key security association (PMKSA) caching is a mechanism to indicate a pairwise master key identifier (PMKID) to a peer device so that an existing PMKSA can be identified to skip the full 802.11 authentication process. Traditionally, a list of zero (e.g., empty) or more PMKIDs is indicated in (Re)Association Request/Response frame. The term (Re)Association means it could be an association or a re-association. However, in 802.11bi, a general mechanism is to utilize authentication frame exchange to derive a PTKSA and encrypt a (Re)association Request/Response frame. Hence, indicating a PMKID in (Re)Association Request/Response frame is not suitable anymore.

As a result, there is a need to indicate PMKID in the authentication frame, especially for 802.1X authentication.

802.11bi defines enhanced data privacy key exchange (EDPKE), which follows the pre-association security negotiation (PASN) flows to have three message exchanges. It is possible to use PMKID with EDPKE, but if the PMKID does not identify a PMKSA, then the originator needs to restart another 802.1X authentication frame exchange to have full authentication and then two message are wasted.

Example embodiments of the present disclosure relate to systems, methods, and devices for fast PMKSA caching under the 802.1X handshake protocol.

Example embodiments of the present disclosure also relate to systems, methods, and devices for UHR/802.11bn TSF/time synchronization protection.

A simpler solution to the TSF problem is to create a full or partial copy of the Timestamp Field in a new Timestamp Element inside the beacon frame containing the full 8 octets identical to the Timestamp Field or a subset thereof including the low-order octets, i.e. starting from the beginning. This element can also be included in any other frame carrying a Timestamp Field if muting is needed for yet-to-be-defined protection of such frames. At the core, this achieves protection of the Timestamp Field and thus time synchronization, but with minimal or no additional cost in hardware for additional MIC calculation happening in parallel to the MIC calculation of the entire frame.

In one embodiment, a PMKID authentication optimization system may indicate PMKID directly in the first message of the 802.1X authentication frame exchange sent from the authentication originator. If the authentication responder identifies the PMKSA using the indicated PMKID, then the extensible authentication protocol over location area network (EAPOL) PDU indicated in the first authentication frame is not processed, the selected PMKID is indicated in the second 802.1X authentication frame for both sides to identify the PMK and proceed with PTKSA derivation to encrypt the following (re)association request/response frame. If the authentication responder does not identify the PMKSA using the indicated PMKID, then no PMKID is indicated in the second authentication frame, and both sides proceed with normal 802.1X authentication flow.

For 802.1X with PMKSA caching: If PMKSA is identified, there may be a two authentication frame exchange followed by a two (re)association frame exchange to complete the process (e.g., a shortened process with respect to full 802.1X authentication). If PMKSA is not identified, there is a same number of authentication frames exchanged to complete the full 802.1X authentication as there is currently. This is better than reusing EDPKE PASN-like flow for PMKSA caching, where: If PMKSA is identified, there are three authentication frames exchanged followed by two (re)association frames exchanged to complete the process. If PMKSA is not identified, there are two authentication frames exchanged with failed PMKSA caching attempts followed by the required number of authentication frames exchanged to complete the full 802.1X authentication.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

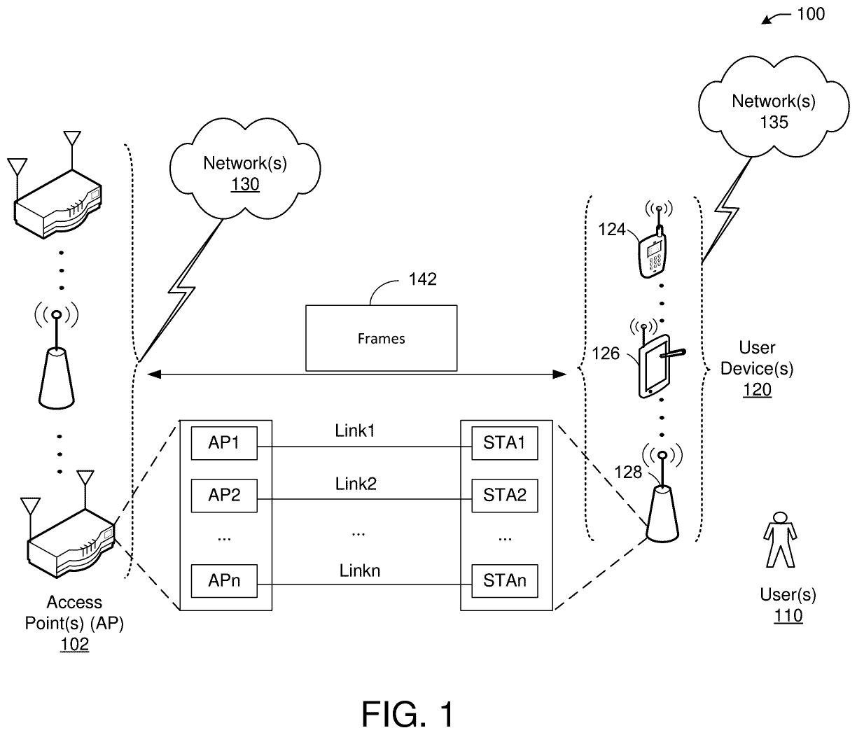

FIG. 1 is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

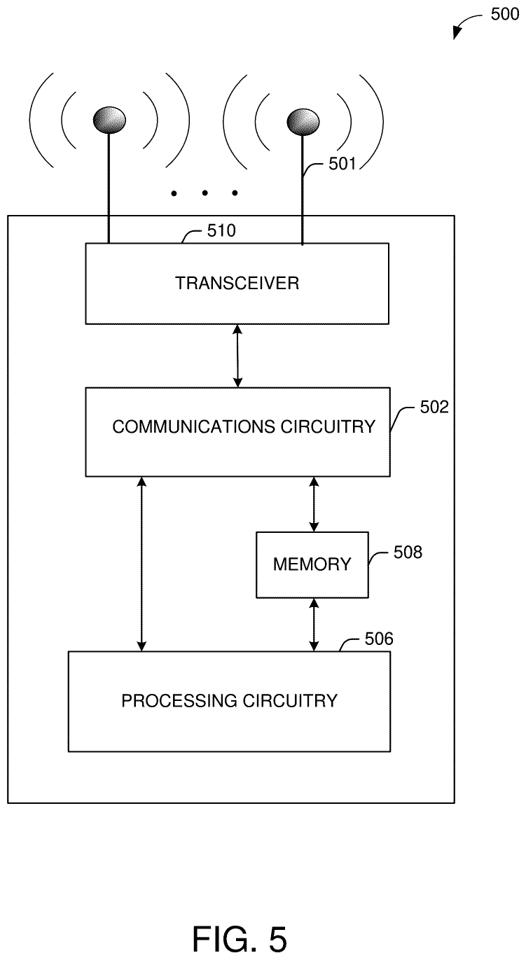

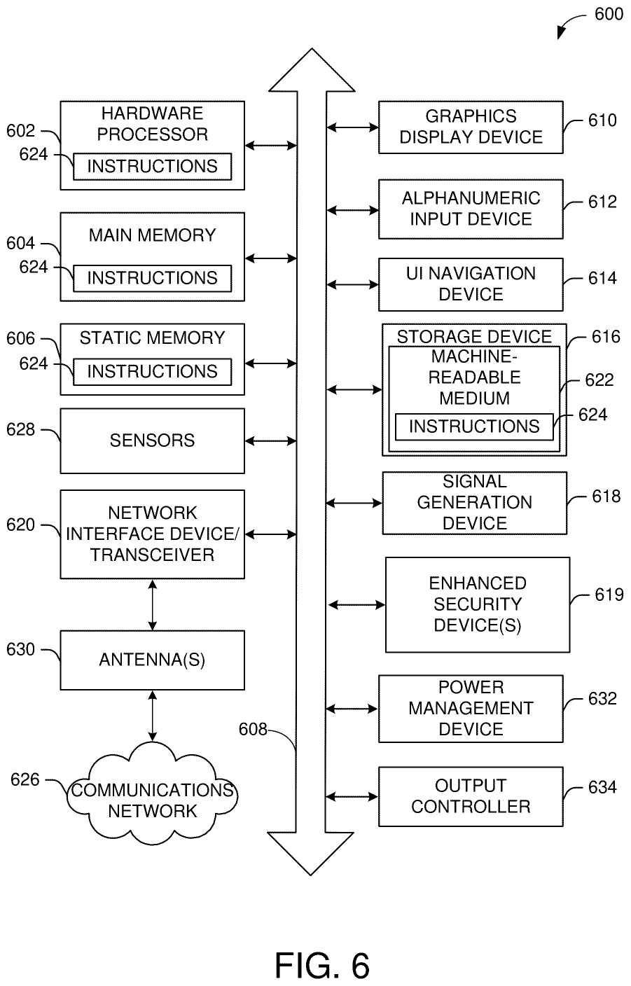

In some embodiments, the user devices 120 and the AP 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802. 11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.1lay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a TSF protection with frames 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

### Definition of the Timestamp Element

To protect the time synchronization, a new Timestamp Element shall be defined as shown in Table 1 below.

TABLE 1
Timestamp Element:

| | | | (Partial) |
|---|---|---|---|
| | Element ID | Length | Timestamp |
| Octets: | 1 | 1 | 1-8 |
| | | | (variable) |

In frames where the Timestamp Field is present, this element shall carry a (possibly truncated) copy of the contents of the Timestamp Field, with as many low-order bits of the Timestamp present as fit into the element and—if truncated—high-order bits truncated. This matches the bit/octet order of the Timestamp Field, i.e. taking the first octets thereof.

In frames where the Timestamp Field is not otherwise already present, the transmitting STA shall set the element's (partial) Timestamp so that it equals the value of the STA's TSF (Timing Synchronization Function) timer at the time that the start of the data symbol containing the first bit of the Timestamp appears at the transmit antenna connector.

NOTE: Other references for the value of the Timestamp in the Timestamp Element in frames not carrying a Timestamp Field could be defined, it just needs to be defined precisely. Protection of the Timestamp in Beacon Frames.

For beacon frames, the Timestamp Element is protected by the MIC in the MME if beacon protection is enabled (otherwise there's no value in this element), and thus follows the desired protection.

If the entire Timestamp (8 octets) is given in the Timestamp Element, the receiving STA that wishes to use the Timestamp value for synchronization simply has to either.
Compare the Timestamp Field and Timestamp Element values, discarding frames that are mismatched and thus detected to be replayed; or
Use only the protected value from the Timestamp Element after MIC validation.

In case the length of the Timestamp Element is shorter than the entire 8 octets, the receiving STA additionally verifies that the upper octets (that are not present in the Element and taken from the Timestamp Field) are correct with respect to the expected value as compared to the local TSF.

In case the AP's beacons do not generally contain the full 8 octets in the Timestamp Element, there's a gap for the protection during the association process, which can be solved in different ways, e.g.

Including the (full) Timestamp Element in e.g. protected Association Response frame, if that is protected.

Periodically including the full 8 octets in the Timestamp Field in the beacon.

Protection of the Timestamp in other Frames:

There are three other frames carrying a Timestamp Field today:
Probe Response Frames.
Timing Advertisement Frames.
TIM Frame.

Currently, there is no protection defined for any of these frames, and in fact the TIM frame is specifically an “Unprotected WNM Action” frame.

It is plausible that none of these require protection as the Beacon Timestamp can be used to synchronize the TSF accurately enough (while ignoring the Timestamp field of these frames):
In the typical use case for unprotected Probe Response frames for network discovery, no timing needs to be synchronized since no connection is yet established.
For Timing Advertisement frames, the whole protocol is currently not protected, so accurately and securely synchronizing a higher-level timestamp (such as UTC time) is not possible with this protocol, thus there's also no need to use the Timestamp field from these frames in a secure manner.
For TIM frames, the use case is power optimization, i.e. to not have to continuously receive all beacons, but at least per the “Check Beacon” counter field beacons do need to be checked occasionally and can also be used for synchronizing the TSF, accurately enough to be able to ignore the Timestamp field in these frames.

In case these frames are regarded as important enough to warrant Timestamp protection, the rest of their contents is certainly just as important:

For probe responses, they contain all data about the AP and potentially other links on the same AP MLD similar to the beacon.

For Timing Advertisement frames, they contain data to do higher-level time synchronization, not having protection on the higher-level information makes the synchronization unprotected, so there's no additional value in protecting only the Timestamp field in these.

For TIM frames, an attacker could cause the clients relying on these frames to arbitrarily wake up to receive beacons and traffic directed to them (which may not even exist), but in that case it would use less power to receive only beacons in the first place and ignore the TIM frames entirely, so protection would be required for all other contents as well.

Additionally, since today no protection for these frames is defined, it is plausible that newly defined protection for them would not mute their respective Timestamp fields and thus automatically protect the value of the Timestamp.

In case this is not possible (note that no 802.11 specification backward compatibility issues exist, but might for existing hardware), the inclusion of the new Timestamp Element with semantics similar to those described in the Beacon frame section above can carry over to these frames as well.

It is noted, however, that to protect these frames raises questions about:

Which keys (IGTK, BIGTK, or another, perhaps new) to use:
For example, using the BIGTK to protect certain (broadcast) frames may not be desirable due to the aperiodic/on-demand nature of those (e.g. probe responses), while using BIGTK to protect periodic (broadcast) frames (such as TIM frames) might be desirable; defining a new key might be undesirable as well, due to needing to keep track of it and rekey it, etc.; the fact that even individually addressed probe response frames should not be encrypted such that if a non-AP STA and the AP STA it is connected to go out of sync wrt. their association state, the non-AP STA can still (re-) discover the AP correctly.
Whether or not it will then be acceptable to use management message integrity code information element (MME) and protection (not encryption) to protect unicast (probe response) frames;
The utility of protecting probe responses, when 802.11bi defines a mechanism for capability exchange using protected frames, which could be extended to include the (full) Timestamp Element if it is defined for frames not carrying a Timestamp Field.

In one or more embodiments, the frames 142 may be used to implement a PMKID authentication with the one or more user devices 120.

It is understood that the above descriptions are for the purposes of illustration and are not meant to be limiting.

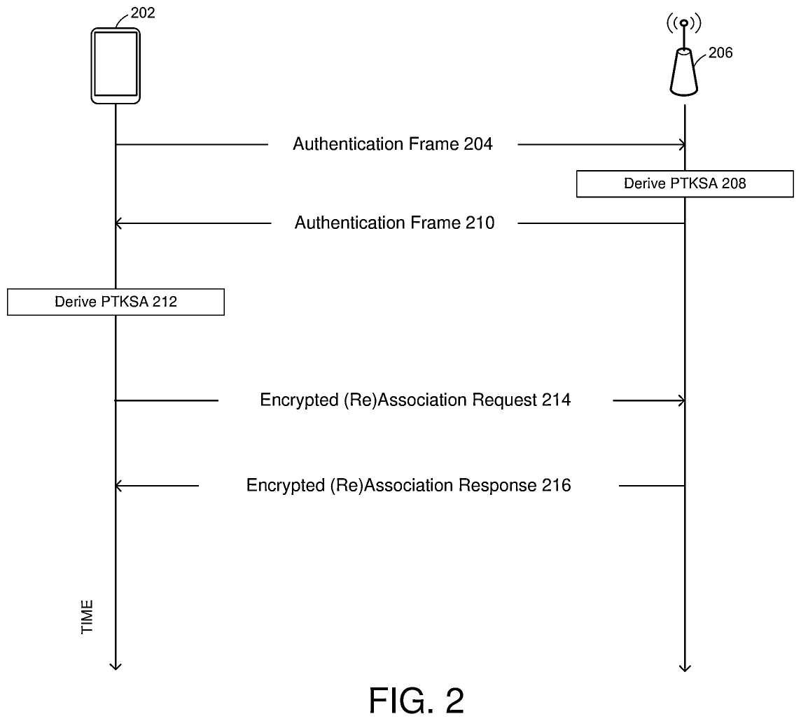

FIG. 2 shows a flow diagram for PMKID authentication optimization, in accordance with one or more example embodiments of the present disclosure.

Referring to FIG. 2, a non-AP STA 202 may send an 802.1X authentication frame 204, including a DH parameter element RSNE (PMKID list)/RSNXE nonce element, to an AP 206. In this manner, the PMKID may be included in the first frame of 802.1X authentication. The AP 206 may derive the PTKSA 208, and may respond to the 802.1X authentication frame 204 with an 802.1X authentication frame 210, including the DH parameter element RSNE (PMKID) and nonce element. The STA 202 may derive the PTKSA 212 from the 802.1X authentication frame 210, and may send an encrypted (re)association request frame 214 to the AP 206. Based on whether the AP 206 associates the STA 202 to a BSSID, the AP 206 may send an encrypted (re)association response frame 216 to the STA 202. FIG. 2 is an example case in which the PMKSA may be identified between AP and STA, so the 802.1X authentication requires only two frames (e.g., the authentication frame 204 and the authentication frame 210), and the association requires only two frames (e.g., the encrypted (re)association request 214 and the encrypted (re)association response 216).

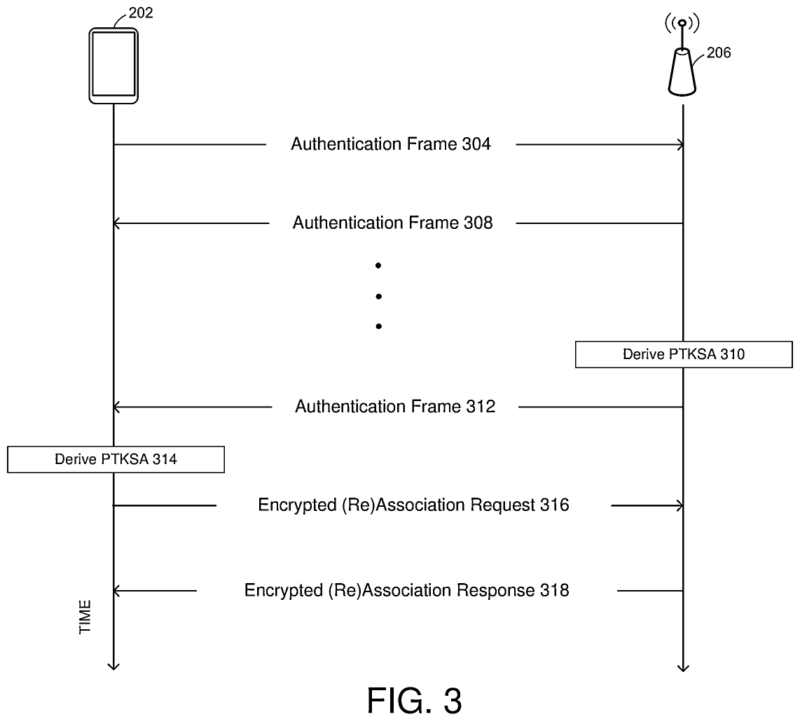

FIG. 3 shows a flow diagram for PMKID authentication optimization, in accordance with one or more example embodiments of the present disclosure.

Referring to FIG. 3, the non-AP STA 202 may send an 802.1X authentication frame 304, including a DH parameter element RSNE (PMKID list)/RSNXE nonce element, to the AP 306. In this manner, the PMKID may be included in the first frame of 802.1X authentication. The AP 206 may respond to the 802.1X authentication frame 304 with an 802.1X authentication frame 308, including the DH parameter element RSNE (no PMKID) and nonce element. In this manner, the AP 206 as the responder is unable to identify the PMKSA based on the PMKID in the authentication frame 304 (e.g., no match), so the exchange may continue with the normal 802.1X handshake. The AP 206 may derive the PTKSA 310 and respond with an authentication frame 312 to the 802.1X authentication frame 304. The STA 202 may derive the PTKSA 314 from the authentication frame 312, and may send an encrypted (re)association request frame 316 to the AP 206. Based on whether the AP 206 associates the STA 202 to a BSSID, the AP 206 may send an encrypted (re)association response frame 316 to the STA 202. FIG. 3 provides an example case in which, under an 802.1X authentication frame exchange, a PMKSA cannot be identified between an AP and a non-AP STA.

Referring to FIGS. 2 and 3, the non-AP STA 202 is the authentication originator and the AP 206 is the authentication responder. For the 802.1X authentication between a non-AP MLD and an AP MLD, the non-AP MLD is the authentication originator and the AP MLD is the authentication responder.

In one or more embodiments, a PMKID authentication optimization system may facilitate the use of the terms authentication originator and authentication responder. For the 802.1X authentication between a non-AP STA and an AP, the non-AP STA is the authentication originator and the AP is the authentication responder. For the 802.1X authentication between a non-AP MLD and an AP MLD, the non-AP MLD is the authentication originator and the AP MLD is the authentication responder.

In one or more embodiments, a PMKID authentication optimization system may facilitate the following: An authentication originator can supply a list of PMK identifiers (PMKID) in the first IEEE 802.1X Authentication frame. After the authentication responder receives the first IEEE 802.1X Authentication frame: Verify that a PMKSA named via a PMKID in the RSNE exists for the specified AKM. If a PMKSA is identified: use PMKSA caching, does not process the EAPOL PDU in the first Authentication frame, and does not include EAPOL PDU in the second authentication frame. Alternatively, when the PMKID corresponding to the PMKSA in the RSNE is included in the second IEEE 802.1X Authentication frame, before sending the second Authentication frame, derive PTK with the identified PMKSA and DHss as defined in 802.11 (Pairwise key hierarchy) and irretrievably delete the shared secret, DHss, upon completion of PTK generation. If no PMKSA is identified: continue the IEEE 802.1X authentication. When the PMKID is not included in the RSNE in the second IEEE 802.1X Authentication frame, after the authentication originator receives the second IEEE 802.1X Authentication frame, if the authentication originator includes one or more PMKID in the first Authentication frame, and the second Authentication frame includes a PMKID, validate that the Encapsulation Length field is set to 0 and validate that the PMKID included in the second Authentication frame matches one of the PMKID(s) indicated in the first Authentication frame. If verification succeeds, use PMKSA caching with the PMKSA identified by the PMKID indicated in the second Authentication frame and does not continue the IEEE 802.1X Authentication frame exchange. If verification fails, the authentication originator shall discard the frame and terminate further protocol processing.

If the authentication originator does not include any PMKID in the first Authentication frame, validate that there is no PMKID included in the second Authentication frame. If verification fails, the authentication originator shall discard the frame and terminate further protocol processing. If a PMKSA is identified, an authentication originator shall derive PTK with the identified PMKSA and DHss as defined in 802.11 (Pairwise key hierarchy) and irretrievably delete the shared secret, DHss, upon completion of PTK generation. The authentication originator and the authentication responder then continue the operation as defined in 802.11 ((Re)Association Request/Response Frame Encryption) to exchange encrypted (Re)Association Request/Response frames with the following additional rules: The Authentication responder shall verify that the RSNE other than the PMKID Count field and the PMKID list field in the (Re)Association Request frame is identical to the RSNE included in the first Authentication frame. Authentication responder shall also verify that the RSNXE in the (Re)Association Request is identical to the RSNXE included in the first Authentication frame. If the validation fails, the authentication responder shall reject the association. The Authentication originator shall verify that the RSNE other than the PMKID Count field and the PMKID list field in the (Re)Association Response frame is the same as the RSNE included in the second Authentication frame. If the validation fails, the authentication originator shall disassociate.

The reference for 802.11 PTK derivation is shown below.

PTK=PRF-Length(PMK, “Pairwise key expansion”, Min(AA,SPA)∥Max(AA,SPA)∥Min(ANonce,SNonce)∥Max(ANonce, SNonce)∥DHss) if key derivation with Authentication frame exchange for IEEE 802.1X is used as defined in Section12.14.7.2 (IEEE 802.1X). DHss generated by the authentication originator and authentication responder follows Section 12.14.7.2 IEEE 802.1X.

It is understood that the above descriptions are for purposes of illustration and are not meant to be limiting.

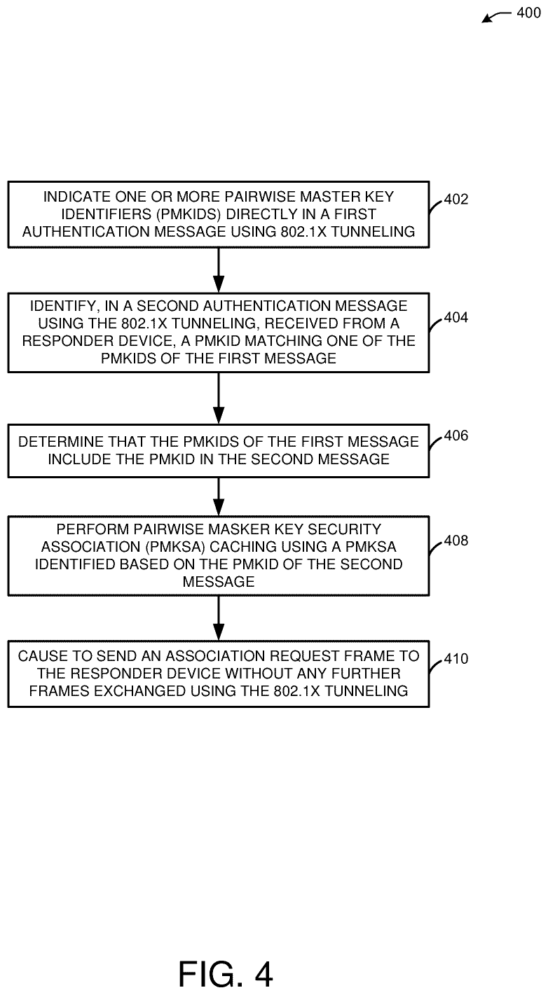

FIG. 4 illustrates a flow diagram of illustrative process for using PMKSA caching for authentication, in accordance with one or more example embodiments of the present disclosure.

At block 402, a device (e.g., a user device 120 of FIG. 1A, the MLD 151 or the MLD 160 of FIG. 1B, the MLD 180 of FIG. IC, the STA 202 of FIG. 2, the enhanced security device 619 of FIG. 6) may indicate one or more PMKIDs directly in a first message of an authentication frame exchange using 802.1X tunneling. The PMKIDs may correspond to PMKSA identifiers.

At block 404, the device may identify a PMKID in a second message of the authentication frame exchange using the 802.1X tunneling, the second message received from a responder device that received the first message of the authentication frame exchange using the 802.1X tunneling.

At block 406, the device may determine that the PMKID of the second message matches a PMKID of the first message (e.g., that the one or more PMKIDs in the first authentication message include the PMKID of the second message, so there is a match). When there is a match, at block 408, the device may perform PMKSA caching using a PMKSA that the device identifies based on the PMKID of the second message. As a result, the device may terminate the authentication exchange with no further frame exchanges using the 802.1X tunneling.

At block 410, the device may perform association by sending a (re)association request to the responder in succession with the second message of the authentication exchange (e.g., the authentication exchange using the 802.1X tunneling consists of only the two frames). The responder may send a (re)association response.

It is understood that the above descriptions are for purposes of illustration and are not meant to be limiting.

FIG. 5 shows a functional diagram of an exemplary communication station 500, in accordance with one or more example embodiments of the present disclosure. In one embodiment, FIG. 5 illustrates a functional block diagram of a communication station that may be suitable for use as an AP 102 (FIG. 1A) or a user device 120 (FIG. 1A) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an enhanced security device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 602 for generation and processing of the baseband signals and for controlling operations of the main memory 604, the storage device 616, and/or the enhanced security device 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced security device 619 may carry out or perform any of the operations and processes (e.g., the processes in FIG. 2 and FIG. 3, process 400) described and shown above.

It is understood that the above are only a subset of what the enhanced security device 619 may be configured to perform and that other functions included throughout this disclosure may also be performed by the enhanced security device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

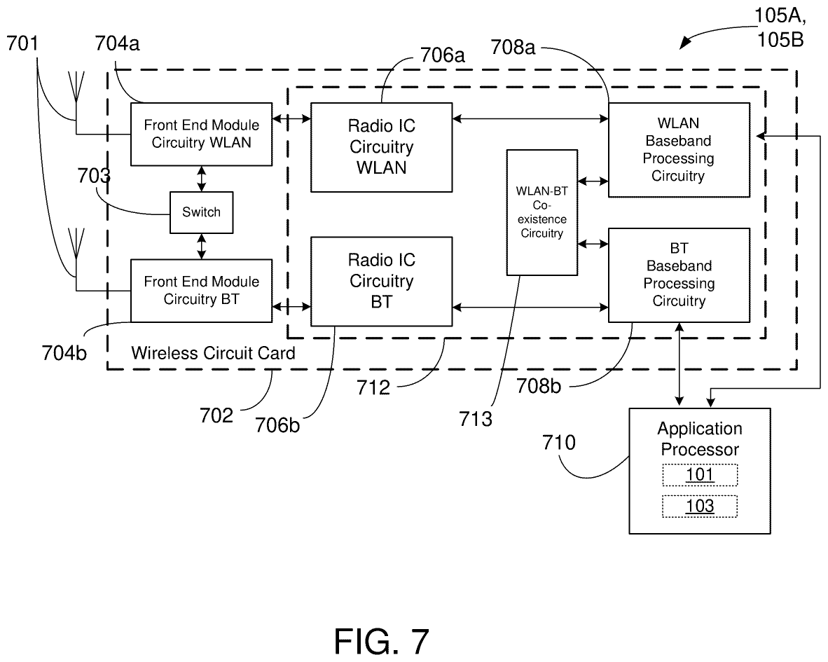

FIG. 7 is a block diagram of a radio architecture 105A, 105B in accordance with some embodiments that may be implemented in any one of the example APs 102 and/or the example STAs 120 of FIG. 1A. Radio architecture 105A, 105B may include radio front-end module (FEM) circuitry 704a-b, radio IC circuitry 706a-b and baseband processing circuitry 708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 704a-b may include a WLAN or Wi-Fi FEM circuitry 704a and a Bluetooth (BT) FEM circuitry 704b. The WLAN FEM circuitry 704a may include a receive signal path comprising circuitry configured to operate on WLAN RF signals received from one or more antennas 701, to amplify the received signals and to provide the amplified versions of the received signals to the WLAN radio IC circuitry 706a for further processing. The BT FEM circuitry 704b may include a receive signal path which may include circuitry configured to operate on BT RF signals received from one or more antennas 701, to amplify the received signals and to provide the amplified versions of the received signals to the BT radio IC circuitry 706b for further processing. FEM circuitry 704a may also include a transmit signal path which may include circuitry configured to amplify WLAN signals provided by the radio IC circuitry 706a for wireless transmission by one or more of the antennas 701. In addition, FEM circuitry 704b may also include a transmit signal path which may include circuitry configured to amplify BT signals provided by the radio IC circuitry 706b for wireless transmission by the one or more antennas. In the embodiment of FIG. 7, although FEM 704a and FEM 704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 706a-b as shown may include WLAN radio IC circuitry 706a and BT radio IC circuitry 706b. The WLAN radio IC circuitry 706a may include a receive signal path which may include circuitry to down-convert WLAN RF signals received from the FEM circuitry 704a and provide baseband signals to WLAN baseband processing circuitry 708a. BT radio IC circuitry 706b may in turn include a receive signal path which may include circuitry to down-convert BT RF signals received from the FEM circuitry 704b and provide baseband signals to BT baseband processing circuitry 708b. WLAN radio IC circuitry 706a may also include a transmit signal path which may include circuitry to up-convert WLAN baseband signals provided by the WLAN baseband processing circuitry 708a and provide WLAN RF output signals to the FEM circuitry 704a for subsequent wireless transmission by the one or more antennas 701. BT radio IC circuitry 706b may also include a transmit signal path which may include circuitry to up-convert BT baseband signals provided by the BT baseband processing circuitry 708b and provide BT RF output signals to the FEM circuitry 704b for subsequent wireless transmission by the one or more antennas 701. In the embodiment of FIG. 7, although radio IC circuitries 706a and 706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 708a-b may include a WLAN baseband processing circuitry 708a and a BT baseband processing circuitry 708b. The WLAN baseband processing circuitry 708a may include a memory, such as, for example, a set of RAM arrays in a Fast Fourier Transform or Inverse Fast Fourier Transform block (not shown) of the WLAN baseband processing circuitry 708a. Each of the WLAN baseband circuitry 708a and the BT baseband circuitry 708b may further include one or more processors and control logic to process the signals received from the corresponding WLAN or BT receive signal path of the radio IC circuitry 706a-b, and to also generate corresponding WLAN or BT baseband signals for the transmit signal path of the radio IC circuitry 706a-b. Each of the baseband processing circuitries 708a and 708b may further include physical layer (PHY) and medium access control layer (MAC) circuitry, and may further interface with a device for generation and processing of the baseband signals and for controlling operations of the radio IC circuitry 706a-b.

Referring still to FIG. 7, according to the shown embodiment, WLAN-BT coexistence circuitry 713 may include logic providing an interface between the WLAN baseband circuitry 708a and the BT baseband circuitry 708b to enable use cases requiring WLAN and BT coexistence. In addition, a switch 703 may be provided between the WLAN FEM circuitry 704a and the BT FEM circuitry 704b to allow switching between the WLAN and BT radios according to application needs. In addition, although the antennas 701 are depicted as being respectively connected to the WLAN FEM circuitry 704a and the BT FEM circuitry 704b, embodiments include within their scope the sharing of one or more antennas as between the WLAN and BT FEMs, or the provision of more than one antenna connected to each of FEM 704a or 704b.

In some embodiments, the front-end module circuitry 704a-b, the radio IC circuitry 706a-b, and baseband processing circuitry 708a-b may be provided on a single radio card, such as wireless radio card 702. In some other embodiments, the one or more antennas 701, the FEM circuitry 704a-b and the radio IC circuitry 706a-b may be provided on a single radio card. In some other embodiments, the radio IC circuitry 706a-b and the baseband processing circuitry 708a-b may be provided on a single chip or integrated circuit (IC), such as IC 712.

In some embodiments, the wireless radio card 702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.1lay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 7, the BT baseband circuitry 708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHZ, 5 GHZ, and bandwidths of about 2 MHZ, 4 MHZ, 5 MHz, 5.5 MHZ, 6 MHz, 8 MHz, 10 MHz, 20 MHz, 40 MHz, 80 MHZ (with contiguous bandwidths) or 80+80 MHZ (160 MHZ) (with non-contiguous bandwidths). In some embodiments, a 920 MHz channel bandwidth may be used. The scope of the embodiments is not limited with respect to the above center frequencies however.

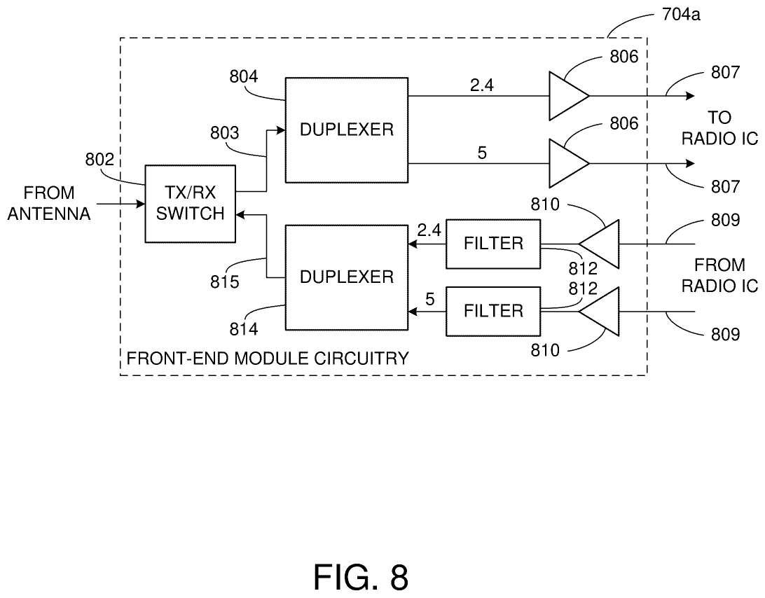

FIG. 8 illustrates WLAN FEM circuitry 804a in accordance with some embodiments. Although the example of FIG. 8 is described in conjunction with the WLAN FEM circuitry 804a, the example of FIG. 8 may be described in conjunction with the example BT FEM circuitry 704b (FIG. 7), although other circuitry configurations may also be suitable.

In some embodiments, the FEM circuitry 704a may include a TX/RX switch 802 to switch between transmit mode and receive mode operation. The FEM circuitry 704a may include a receive signal path and a transmit signal path. The receive signal path of the FEM circuitry 704a may include a low-noise amplifier (LNA) 806 to amplify received RF signals 803 and provide the amplified received RF signals 807 as an output (e.g., to the radio IC circuitry 706a-b (FIG. 7)). The transmit signal path of the circuitry 704a may include a power amplifier (PA) to amplify input RF signals 809 (e.g., provided by the radio IC circuitry 706a-b), and one or more filters 812, such as band-pass filters (BPFs), low-pass filters (LPFs) or other types of filters, to generate RF signals 815 for subsequent transmission (e.g., by one or more of the antennas 701 (FIG. 7)) via an example duplexer 814.

In some dual-mode embodiments for Wi-Fi communication, the FEM circuitry 704a may be configured to operate in either the 2.4 GHz frequency spectrum or the 5 GHz frequency spectrum. In these embodiments, the receive signal path of the FEM circuitry 704a may include a receive signal path duplexer 804 to separate the signals from each spectrum as well as provide a separate LNA 806 for each spectrum as shown. In these embodiments, the transmit signal path of the FEM circuitry 704a may also include a power amplifier 810 and a filter 812, such as a BPF, an LPF or another type of filter for each frequency spectrum and a transmit signal path duplexer 804 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

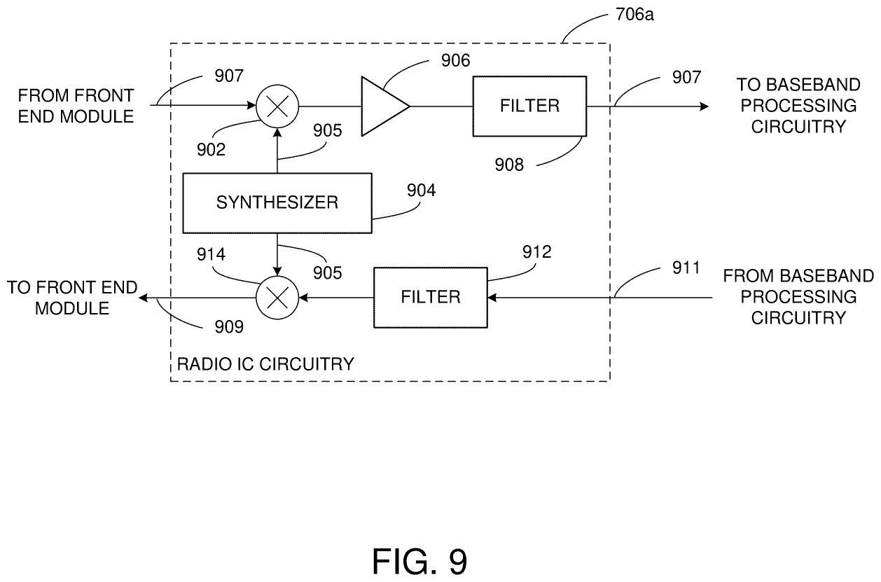

FIG. 9 illustrates radio IC circuitry 706a in accordance with some embodiments. The radio IC circuitry 706a is one example of circuitry that may be suitable for use as the WLAN or BT radio IC circuitry 706a/706b (FIG. 7), although other circuitry configurations may also be suitable. Alternatively, the example of FIG. 9 may be described in conjunction with the example BT radio IC circuitry 706b.

In some embodiments, the radio IC circuitry 706a may include a receive signal path and a transmit signal path. The receive signal path of the radio IC circuitry 706a may include at least mixer circuitry 902, such as, for example, down-conversion mixer circuitry, amplifier circuitry 906 and filter circuitry 908. The transmit signal path of the radio IC circuitry 706a may include at least filter circuitry 912 and mixer circuitry 914, such as, for example, up-conversion mixer circuitry. Radio IC circuitry 706a may also include synthesizer circuitry 904 for synthesizing a frequency 905 for use by the mixer circuitry 902 and the mixer circuitry 914. The mixer circuitry 902 and/or 914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 9 illustrates only a simplified version of a radio IC circuitry, and may include, although not shown, embodiments where each of the depicted circuitries may include more than one component. For instance, mixer circuitry 914 may each include one or more mixers, and filter circuitries 908 and/or 912 may each include one or more filters, such as one or more BPFs and/or LPFs according to application needs. For example, when mixer circuitries are of the direct-conversion type, they may each include two or more mixers.

In some embodiments, mixer circuitry 902 may be configured to down-convert RF signals 807 received from the FEM circuitry 704a-b (FIG. 7) based on the synthesized frequency 905 provided by synthesizer circuitry 904. The amplifier circuitry 906 may be configured to amplify the down-converted signals and the filter circuitry 908 may include an LPF configured to remove unwanted signals from the down-converted signals to generate output baseband signals 907. Output baseband signals 907 may be provided to the baseband processing circuitry 708a-b (FIG. 7) for further processing. In some embodiments, the output baseband signals 907 may be zero-frequency baseband signals, although this is not a requirement. In some embodiments, mixer circuitry 902 may comprise passive mixers, although the scope of the embodiments is not limited in this respect.

In some embodiments, the mixer circuitry 914 may be configured to up-convert input baseband signals 911 based on the synthesized frequency 905 provided by the synthesizer circuitry 904 to generate RF output signals 809 for the FEM circuitry 704a-b. The baseband signals 911 may be provided by the baseband processing circuitry 708a-b and may be filtered by filter circuitry 912. The filter circuitry 912 may include an LPF or a BPF, although the scope of the embodiments is not limited in this respect.

In some embodiments, the mixer circuitry 902 and the mixer circuitry 914 may each include two or more mixers and may be arranged for quadrature down-conversion and/or up-conversion respectively with the help of synthesizer 904. In some embodiments, the mixer circuitry 902 and the mixer circuitry 914 may each include two or more mixers each configured for image rejection (e.g., Hartley image rejection). In some embodiments, the mixer circuitry 902 and the mixer circuitry 914 may be arranged for direct down-conversion and/or direct up-conversion, respectively. In some embodiments, the mixer circuitry 902 and the mixer circuitry 914 may be configured for super-heterodyne operation, although this is not a requirement.

Mixer circuitry 902 may comprise, according to one embodiment: quadrature passive mixers (e.g., for the in-phase (I) and quadrature phase (Q) paths). In such an embodiment, RF input signal 807 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 905 of synthesizer 904 (FIG. 9). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 807 (FIG. 8) may comprise a balanced signal, although the scope of the embodiments is not limited in this respect. The I and Q baseband output signals may be provided to low-noise amplifier, such as amplifier circuitry 906 (FIG. 9) or to filter circuitry 908 (FIG. 9).

In some embodiments, the output baseband signals 907 and the input baseband signals 911 may be analog baseband signals, although the scope of the embodiments is not limited in this respect. In some alternate embodiments, the output baseband signals 907 and the input baseband signals 911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 904 may be a fractional-N synthesizer or a fractional N/N+1 synthesizer, although the scope of the embodiments is not limited in this respect as other types of frequency synthesizers may be suitable. For example, synthesizer circuitry 904 may be a delta-sigma synthesizer, a frequency multiplier, or a synthesizer comprising a phase-locked loop with a frequency divider. According to some embodiments, the synthesizer circuitry 904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 904 may be provided by a voltage controlled oscillator (VCO), although that is not a requirement. A divider control input may further be provided by either the baseband processing circuitry 808a-b (FIG. 8) depending on the desired output frequency 905. In some embodiments, a divider control input (e.g., N) may be determined from a look-up table (e.g., within a Wi-Fi card) based on a channel number and a channel center frequency as determined or indicated by the example application processor 710. The application processor 710 may include, or otherwise be connected to, one of the example secure signal converter 101 or the example received signal converter 103 (e.g., depending on which device the example radio architecture is implemented in).

In some embodiments, synthesizer circuitry 904 may be configured to generate a carrier frequency as the output frequency 905, while in other embodiments, the output frequency 905 may be a fraction of the carrier frequency (e.g., one-half the carrier frequency, one-third the carrier frequency). In some embodiments, the output frequency 905 may be a LO frequency (fLO).

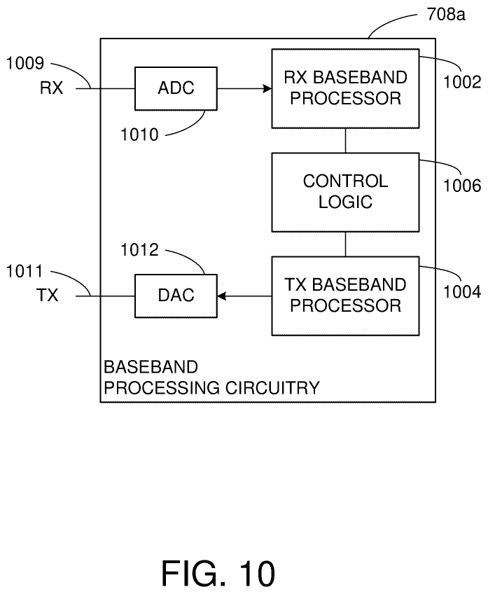

FIG. 10 illustrates a functional block diagram of baseband processing circuitry 708a in accordance with some embodiments. The baseband processing circuitry 708a is one example of circuitry that may be suitable for use as the baseband processing circuitry 708a (FIG. 7), although other circuitry configurations may also be suitable. Alternatively, the example of FIG. 9 may be used to implement the example BT baseband processing circuitry 708b of FIG. 7.

The baseband processing circuitry 708a may include a receive baseband processor (RX BBP) 1002 for processing receive baseband signals 909 provided by the radio IC circuitry 706a-b (FIG. 7) and a transmit baseband processor (TX BBP) 1004 for generating transmit baseband signals 911 for the radio IC circuitry 706a-b. The baseband processing circuitry 708a may also include control logic 1006 for coordinating the operations of the baseband processing circuitry 708a.

In some embodiments (e.g., when analog baseband signals are exchanged between the baseband processing circuitry 708a-b and the radio IC circuitry 706a-b), the baseband processing circuitry 708a may include ADC 1010 to convert analog baseband signals 1009 received from the radio IC circuitry 706a-b to digital baseband signals for processing by the RX BBP 1002. In these embodiments, the baseband processing circuitry 708a may also include DAC 1012 to convert digital baseband signals from the TX BBP 1004 to analog baseband signals 1011.

In some embodiments that communicate OFDM signals or OFDMA signals, such as through baseband processor 708a, the transmit baseband processor 1004 may be configured to generate OFDM or OFDMA signals as appropriate for transmission by performing an inverse fast Fourier transform (IFFT). The receive baseband processor 1002 may be configured to process received OFDM signals or OFDMA signals by performing an FFT. In some embodiments, the receive baseband processor 1002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 7, in some embodiments, the antennas 701 (FIG. 7) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID clement or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include an apparatus of a device for using pairwise master key security association (PMKSA) caching for authentication, the device comprising processing circuitry coupled to storage, the processing circuitry configured to: cause to send a first authentication frame using 802.1X tunneling, the first authentication frame comprising an indication of one or more pairwise master key identifier (PMKIDs) associated with one or more PMKSAs; identify a first PMKID indicated in a second authentication frame using the 802.1X tunneling, received from a responder device; determine that the one or more PMKIDs in the first authentication frame comprise the first PMKID indicated in the second authentication frame; store a PMKSA identifier corresponding to the first PMKID; and cause to send an association request frame to the responder device based on determining that the one or more PMKIDs in the first authentication frame comprise the first PMKID indicated in the second authentication frame, wherein the association request frame is sent in succession with receiving the second authentication frame.

Example 2 may include the apparatus of example 1 and/or any other example herein, wherein the processing circuitry is further configured to terminate an authentication frame exchange using the 802.1X tunneling based on determining that the one or more PMKIDs in the first authentication frame comprise the first PMKID indicated in the second authentication frame.

Example 3 may include the apparatus of example 1 and/or any other example herein, wherein the first authentication frame further comprises a first nonce element, and wherein the second authentication frame further comprises a second nonce element.

Example 4 may include the apparatus of example 1 and/or any other example herein, wherein the first PMKID is based on a PMKSA corresponding to the one or more PMKIDs.

Example 5 may include the apparatus of example 1 and/or any other example herein apparatus of claim 1, wherein the processing circuitry is further configured to: cause to send a third authentication frame using a second 802.1X tunneling, the third authentication frame comprising one or more second PMKIDs; identify a second PMKID indicated in a fourth authentication frame using the second 802.1X tunneling, received from a second responder device; determine that that the one or more second PMKIDs in the third authentication frame do not include the second PMKID indicated in the fourth authentication frame; and discard the fourth authentication frame and terminate the second 802.1X tunneling.

Example 6 may include the apparatus of example 1 and/or any other example herein, wherein the processing circuitry is further configured to: cause to send a third authentication frame using a second 802.1X tunneling, the third authentication frame comprising one or more second PMKIDs; and identify a fourth authentication frame using the second 802.1X tunneling, received from a second responder device and indicating that an authentication frame exchange using the second 802.1X tunneling is to be continued.

Example 7 may include the apparatus of example 1 and/or any other example herein, further comprising a transceiver configured to transmit and receive wireless signals comprising the first authentication frame, the second authentication frame, and the association request.

Example 8 may include the apparatus of example 6 and/or any other example herein, further comprising an antenna coupled to the transceiver to cause the device to send the first authentication frame and the association request.

Example 9 may include the apparatus of example 1 and/or any other example herein apparatus of claim 1, wherein the device is a multi-link device.

Example 10 may include a non-transitory computer-readable medium storing instructions to cause processing circuitry of a device for using pairwise master key security association (PMKSA) caching for authentication, upon execution of the instructions by the processing circuitry, to: cause to send a first authentication frame using 802.1X tunneling, the first authentication frame comprising an indication of one or more pairwise master key identifier (PMKIDs) associated with one or more PMKSAs; identify a first PMKID indicated in a second authentication frame using the 802.1X tunneling, received from a responder device; determine that the one or more PMKIDs in the first authentication frame comprise the first PMKID indicated in the second authentication frame; store a PMKSA identifier corresponding to the first PMKID; and cause to send an association request frame to the responder device based on determining that the one or more PMKIDs in the first authentication frame comprise the first PMKID indicated in the second authentication frame, wherein the association request frame is sent in succession with receiving the second authentication frame.

Example 11 may include the non-transitory computer-readable medium of example 10 and/or any other example herein, wherein execution of the instructions further causes the processing circuitry to terminate an authentication frame exchange using the 802.1X tunneling based on determining that the one or more PMKIDs in the first authentication frame comprise the first PMKID indicated in the second authentication frame.

Example 12 may include the non-transitory computer-readable medium of example 10 and/or any other example herein, wherein the first authentication frame further comprises a first nonce clement, and wherein the second authentication frame further comprises a second nonce element.

Example 13 may include the non-transitory computer-readable medium of example 10 and/or any other example herein, wherein the first PMKID is based on a PMKSA corresponding to the one or more PMKIDS.

Example 14 may include the non-transitory computer-readable medium of example 10 and/or any other example herein, wherein execution of the instructions further causes the processing circuitry to: cause to send a third authentication frame using a second 802.1X tunneling, the third authentication frame comprising one or more second PMKIDs; identify a second PMKID indicated in a fourth authentication frame using the second 802.1X tunneling, received from a second responder device; determine that that the one or more second PMKIDS in the third authentication frame do not include the second PMKID indicated in the fourth authentication frame; and discard the fourth authentication frame and terminate the second 802.1X tunneling.

Example 15 may include the non-transitory computer-readable medium of example 10 and/or any other example herein, wherein execution of the instructions further causes the processing circuitry to: cause to send a third authentication frame using a second 802.1X tunneling, the third authentication frame comprising one or more second PMKIDs; and identify a fourth authentication frame using the second 802.1X tunneling, received from a second responder device and indicating that an authentication frame exchange using the second 802.1X tunneling is to be continued.

Example 16 may include a method for using pairwise master key security association (PMKSA) caching for authentication, the method comprising: causing to send, by processing circuitry of an originator device, a first authentication frame using 802.1X tunneling, the first authentication frame comprising an indication of one or more pairwise master key identifier (PMKIDs) associated with one or more PMKSAs; identifying, by the processing circuitry, a first PMKID indicated in a second authentication frame using the 802.1X tunneling, received from a responder device; determining, by the processing circuitry, that the one or more PMKIDs in the first authentication frame comprise the first PMKID indicated in the second authentication frame; storing, by the processing circuitry, a PMKSA identifier corresponding to the first PMKID; and causing to send, by the processing circuitry, an association request frame to the responder device based on determining that the one or more PMKIDs in the first authentication frame comprise the first PMKID indicated in the second authentication frame, wherein the association request frame is sent in succession with receiving the second authentication frame.

Example 17 may include the method of example 15 and/or any other example herein, further comprising terminating an authentication frame exchange using the 802.1X tunneling based on determining that the one or more PMKIDs in the first authentication frame comprise the first PMKID indicated in the second authentication frame.

Example 18 may include the method of example 16 and/or any other example herein, wherein the first PMKID is based on a PMKSA corresponding to the one or more PMKIDS.

Example 19 may include the method of example 16 and/or any other example herein: causing to send a third authentication frame using a second 802.1X tunneling, the third authentication frame comprising one or more second PMKIDs; identifying a second PMKID indicated in a fourth authentication frame using the second 802.1X tunneling, received from a second responder device; determining that that the one or more second PMKIDs in the third authentication frame do not include the second PMKID indicated in the fourth authentication frame; and discard the fourth authentication frame and terminate the second 802.1X tunneling.

Example 20 may include the method of example 16 and/or any other example herein, further comprising: causing to send a third authentication frame using a second 802.1X tunneling, the third authentication frame comprising one or more second PMKIDS; and identifying a fourth authentication frame using the second 802.1X tunneling, received from a second responder device and indicating that an authentication frame exchange using the second 802.1X tunneling is to be continued.

Example 21 may include an apparatus including means for: causing to send a first authentication frame using 802.1X tunneling, the first authentication frame comprising an indication of one or more pairwise master key identifier (PMKIDs) associated with one or more PMKSAs; identifying a first PMKID indicated in a second authentication frame using the 802.1X tunneling, received from a responder device; determining that the one or more PMKIDS in the first authentication frame comprise the first PMKID indicated in the second authentication frame; storing a PMKSA identifier corresponding to the first PMKID; and causing to send an association request frame to the responder device based on determining that the one or more PMKIDs in the first authentication frame comprise the first PMKID indicated in the second authentication frame, wherein the association request frame is sent in succession with receiving the second authentication frame.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of a device for using pairwise master key security association (PMKSA) caching for authentication, the device comprising processing circuitry coupled to storage, the processing circuitry configured to:
cause to send a first authentication frame using 802.1X tunneling, the first authentication frame comprising an indication of one or more pairwise master key identifier (PMKIDs) associated with one or more PMKSAs;
identify a first PMKID indicated in a second authentication frame using the 802.1X tunneling, received from a responder device;
determine that the one or more PMKIDs in the first authentication frame comprise the first PMKID indicated in the second authentication frame;
store a PMKSA identifier corresponding to the first PMKID; and
cause to send an association request frame to the responder device based on determining that the one or more PMKIDs in the first authentication frame comprise the first PMKID indicated in the second authentication frame, wherein the association request frame is sent in succession with receiving the second authentication frame.

2. The apparatus of claim 1, wherein the processing circuitry is further configured to terminate an authentication frame exchange using the 802.1X tunneling based on determining that the one or more PMKIDs in the first authentication frame comprise the first PMKID indicated in the second authentication frame.

3. The apparatus of claim 1, wherein the first authentication frame further comprises a first nonce element, and wherein the second authentication frame further comprises a second nonce element.

4. The apparatus of claim 1, wherein the first PMKID is based on a PMKSA corresponding to the one or more PMKIDS.

5. The apparatus of claim 1, wherein the processing circuitry is further configured to:
cause to send a third authentication frame using a second 802.1X tunneling, the third authentication frame comprising one or more second PMKIDS;
identify a second PMKID indicated in a fourth authentication frame using the second 802.1X tunneling, received from a second responder device;
determine that that the one or more second PMKIDs in the third authentication frame do not include the second PMKID indicated in the fourth authentication frame; and
discard the fourth authentication frame and terminate the second 802.1X tunneling.

6. The apparatus of claim 1, wherein the processing circuitry is further configured to:
cause to send a third authentication frame using a second 802.1X tunneling, the third authentication frame comprising one or more second PMKIDs; and
identify a fourth authentication frame using the second 802.1X tunneling, received from a second responder device and indicating that an authentication frame exchange using the second 802.1X tunneling is to be continued.

7. The apparatus of claim 1, further comprising a transceiver configured to transmit and receive wireless signals comprising the first authentication frame, the second authentication frame, and the association request.

8. The apparatus of claim 7, further comprising an antenna coupled to the transceiver to cause the device to send the first authentication frame and the association request.

9. The apparatus of claim 1, wherein the device is a multi-link device.

10. A non-transitory computer-readable medium storing instructions to cause processing circuitry of a device for using pairwise master key security association (PMKSA) caching for authentication, upon execution of the instructions by the processing circuitry, to:
cause to send a first authentication frame using 802.1X tunneling, the first authentication frame comprising an indication of one or more pairwise master key identifier (PMKIDs) associated with one or more PMKSAs;
identify a first PMKID indicated in a second authentication frame using the 802.1X tunneling, received from a responder device;
determine that the one or more PMKIDs in the first authentication frame comprise the first PMKID indicated in the second authentication frame;
store a PMKSA identifier corresponding to the first PMKID; and
cause to send an association request frame to the responder device based on determining that the one or more PMKIDs in the first authentication frame comprise the first PMKID indicated in the second authentication frame, wherein the association request frame is sent in succession with receiving the second authentication frame.

11. The non-transitory computer-readable medium of claim 10, wherein execution of the instructions further causes the processing circuitry to terminate an authentication frame exchange using the 802.1X tunneling based on determining that the one or more PMKIDs in the first authentication frame comprise the first PMKID indicated in the second authentication frame.

12. The non-transitory computer-readable medium of claim 10, wherein the first authentication frame further comprises a first nonce element, and wherein the second authentication frame further comprises a second nonce element.

13. The non-transitory computer-readable medium of claim 10, wherein the first PMKID is based on a PMKSA corresponding to the one or more PMKIDs.

14. The non-transitory computer-readable medium of claim 10, wherein execution of the instructions further causes the processing circuitry to:
cause to send a third authentication frame using a second 802.1X tunneling, the third authentication frame comprising one or more second PMKIDS;
identify a second PMKID indicated in a fourth authentication frame using the second 802.1X tunneling, received from a second responder device;
determine that that the one or more second PMKIDs in the third authentication frame do not include the second PMKID indicated in the fourth authentication frame; and
discard the fourth authentication frame and terminate the second 802.1X tunneling.

15. The non-transitory computer-readable medium of claim 10, wherein execution of the instructions further causes the processing circuitry to:
cause to send a third authentication frame using a second 802.1X tunneling, the third authentication frame comprising one or more second PMKIDs; and
identify a fourth authentication frame using the second 802.1X tunneling, received from a second responder device and indicating that an authentication frame exchange using the second 802.1X tunneling is to be continued.

16. A method for using pairwise master key security association (PMKSA) caching for authentication, the method comprising:
causing to send, by processing circuitry of an originator device, a first authentication frame using 802.1X tunneling, the first authentication frame comprising an indication of one or more pairwise master key identifier (PMKIDs) associated with one or more PMKSAs;
identifying, by the processing circuitry, a first PMKID indicated in a second authentication frame using the 802.1X tunneling, received from a responder device;
determining, by the processing circuitry, that the one or more PMKIDs in the first authentication frame comprise the first PMKID indicated in the second authentication frame;
storing, by the processing circuitry, a PMKSA identifier corresponding to the first PMKID; and
causing to send, by the processing circuitry, an association request frame to the responder device based on determining that the one or more PMKIDs in the first authentication frame comprise the first PMKID indicated in the second authentication frame, wherein the association request frame is sent in succession with receiving the second authentication frame.

17. The method of claim 16, further comprising terminating an authentication frame exchange using the 802.1X tunneling based on determining that the one or more PMKIDs in the first authentication frame comprise the first PMKID indicated in the second authentication frame.

18. The method of claim 16, wherein the first PMKID is based on a PMKSA corresponding to the one or more PMKIDs.

19. The method of claim 16, further comprising:
causing to send a third authentication frame using a second 802.1X tunneling, the third authentication frame comprising one or more second PMKIDS;
identifying a second PMKID indicated in a fourth authentication frame using the second 802.1X tunneling, received from a second responder device;
determining that that the one or more second PMKIDs in the third authentication frame do not include the second PMKID indicated in the fourth authentication frame; and
discard the fourth authentication frame and terminate the second 802.1X tunneling.

20. The method of claim 16, further comprising:
causing to send a third authentication frame using a second 802.1X tunneling, the third authentication frame comprising one or more second PMKIDs; and
identifying a fourth authentication frame using the second 802.1X tunneling, received from a second responder device and indicating that an authentication frame exchange using the second 802.1X tunneling is to be continued.
